(19) United States
(12) Patent Application Publication
(10) Pub. No.: US 2011/0094153 A1
(43) Pub. Date: Apr. 28, 2011

(54) Vertical wall garden

(75) Inventor: Humberto Urriola, Castle Cove (AU)

(73) Assignee: Astral Property Pty Ltd

(21) Appl. No.: 12/923,661

(22) Filed: Oct. 1, 2010

(30) Foreign Application Priority Data
Oct. 27, 2009 (AU) 2009905241

(51) Int. Cl. A01G 9/02; A01C 14/00

(52) U.S. Cl. 47/65.7; 47/66.5; 111/100

(57) ABSTRACT

A vertical wall garden made from modular perforated plastics wall members, which form a back walls, compartment walls and horizontal shelf members, whereby the back walls, compartment walls and horizontal shelf members, interlock with each other to form a layer of box like plant holding compartments with an open face. A first layer is positioned against a vertical wall with the open face facing outwardly from the wall, and additional layers are connected on top of each other until the required height of vertical wall garden is reached. The layers are then secured to the vertical wall. Plants are then placed in water permeable containers with soil and placed in the holding compartments with the plants facing outwardly from the wall. Watering means can be connected to wall garden to supply water to each plant. Thusthere is provided structural plastics support modules which are connected together to form a vertical wall garden which is fast to install, easy fixing on walls both indoors and outdoors, provides a friendly plant habitat and easy maintenance. Further the wall garden can support a large vertical load ofplants and soil.

### BACKGROUND OF THE INVENTION

The present invention relates to a vertical wall garden and in particular to a modular plastics wall garden and also to a method of constructing a vertical wall garden and in particular to a method of constructing a modular plastics wall garden.

Prior art vertical gardens comprise growing medium enclosed in mesh bags which are punctured and the plants planted in the puncture. Thus the system is only suitable for young plants. Further the wall garden cannot support a large vertical load of plants and soil.

### SUMMARY OF THE INVENTION

The present invention provides a structural support module of geocomposite vertical wall garden which is fast to install, easy fixing on walls both indoors and outdoors, provides a friendly plant habitat and easy maintenance. Further the wall garden can support a large vertical load of plants and soil.

In one broad form the invention provides a structural garden wall module comprising:
at least two horizontal members;
two or more vertical members which are connected between the at least two horizontal forming at least one void therebetween which is of sufficient size to hold at least one plant container facing horizontally outwardly from the support module.

In one embodiment the boxes are perforated, and the soil is enclosed in a water permeable geotextile or plastic perforate plant pot with permeable filter liner covering the open face of the plant pot.

Preferably the boxes are the patented Atlantis plastics tank modules.

In another form the invention comprises a method of constructing a vertical wall garden comprising the steps of:
assembling support modules by connecting two end vertical plate members between two horizontal plate members forming a void therebetween with two open faces;
forming a first layer of support modules by connecting the modules to or positioning the modules against adjacent modules in a side by side manner;
connecting said layer to a wall, with an open face of each module extending outwardly from the wall;
positioning further layers of said support modules above the first layer and connecting them to the wall with the open face of each module extending outwardly from the wall, until the required height of the wall garden is reached;
placing means to hold a plant and soil within a plant container when it is horizontal; and
placing said plant containers into the support modules with the open faces of the plant containers and plants facing outwardly from the wall.

In one embodiment of the present invention the plate members are top and bottom planar members which are held spaced apart by columnar spacer members so that the structure is cellular in nature.

In yet a further form the invention comprises a wall garden comprising:
a plurality of horizontal layers of plate members connected together;
vertical wall members connecting adjacent horizontal layers of plate members to each other to form chambers to hold plant containers;
connector means to secure the garden wall to a wall;
plant contains located in said chambers with the plants extending externally of the wall.

Preferably there is a watering system within the garden wall.

In a further form the invention comprises a wall garden support structure comprising:
a plurality of horizontal layers ofplate members connected together;
vertical wall members connecting adjacent horizontal layers of plate members to each other to form chambers to hold plant containers, and
connector means to secure the garden wall support structure to a wall.

In one broad form the invention provides a method of constructing a structural wall garden using modular plant holders and plants in plastics pots having drain holes therein comprising:
stacking the plastics modular plant holders against a wall with the open face of the plastics plant holders facing outwardly from the wall;
affixing said modular plant holders to the wall;
removing said plant and its surrounding soil from its plastics pot;
placing the plant and its surrounding soil into a water permeable geotextile bag having a draw string opening;
closing the draw string opening around the base of the plant to retain the plant and its soil within the bag;
forming an opening in the side of the thus empty plastics pot and drain holes on the opposite side thereof;
placing the thus closed bag into the cut plastics pot;
placing the plastics pot with the bagged plant into one of the modular plant holders, with the plant facing out of the open face of the plastics modular plant holder and the opening in the side of the plastics pot facing upwardly and the drain holes facing downwardly.

In one embodiment the plastics modular plant holder comprises
at least two horizontal members;
two or more vertical members which are connected between the at least two horizontal forming at least one void therebetween which is of sufficient size to hold at least one plant container facing horizontally outwardly from the support module.

Preferably the boxes are the patented Atlantis plastics tank modules.

In yet another form the invention comprises a method of constructing a vertical wall garden comprising the steps of:
assembling support modules by connecting two end vertical plate members between two horizontal plate members forming a void therebetween with two open faces;
forming a first layer of support modules by connecting the modules to or positioning the modules against adjacent modules in a side by side manner;
connecting said layer to a wall, with an open face of each module extending outwardly from the wall;
positioning further layers of said support modules above the first layer and connecting them to the wall with the open face of each module extending outwardly from the wall, until the required height of the wall garden is reached;
removing a plant and its surrounding soil from its plastics pot;
placing the plant and its surrounding soil into a water permeable geotextile bag having a draw string opening;
closing the draw string opening around the base of the plant to retain the plant and its soil within the bag;
placing the bagged plant into one of the modular plant holders, with the plant facing out of the open face of the plastics modular plant holder.

In one broad form the invention provides a method of constructing a structural wall garden using modular plant holders and plants in plastics pots having drain holes therein comprising:
stacking the plastics modular plant holders against a wall with the open face of the plastics plant holders facing outwardly from the wall;
affixing said modular plant holders to the wall;
removing said plant and its surrounding soil from its plastics pot;
placing the plant and its surrounding soil into a water permeable geotextile bag having a draw string opening;
closing the draw string opening around the base of the plant to retain the plant and its soil within the bag;
forming an opening in the side of the thus empty plastics pot and drain holes on the opposite side;
placing the thus closed bag into the cut plastics pot;
placing the plastics pot with the bagged plant into one of the modular plant holders, with the plant facing out of the open face of the plastics modular plant holder and the opening in the side of the plastics pot facing upwardly and the drain holes facing downwardly.

Preferably there is a watering system within the wall garden.

BREIF DESCRIPTION OF THE DRAWINGS

The invention will now be described with reference to the accompanying drawings in which:

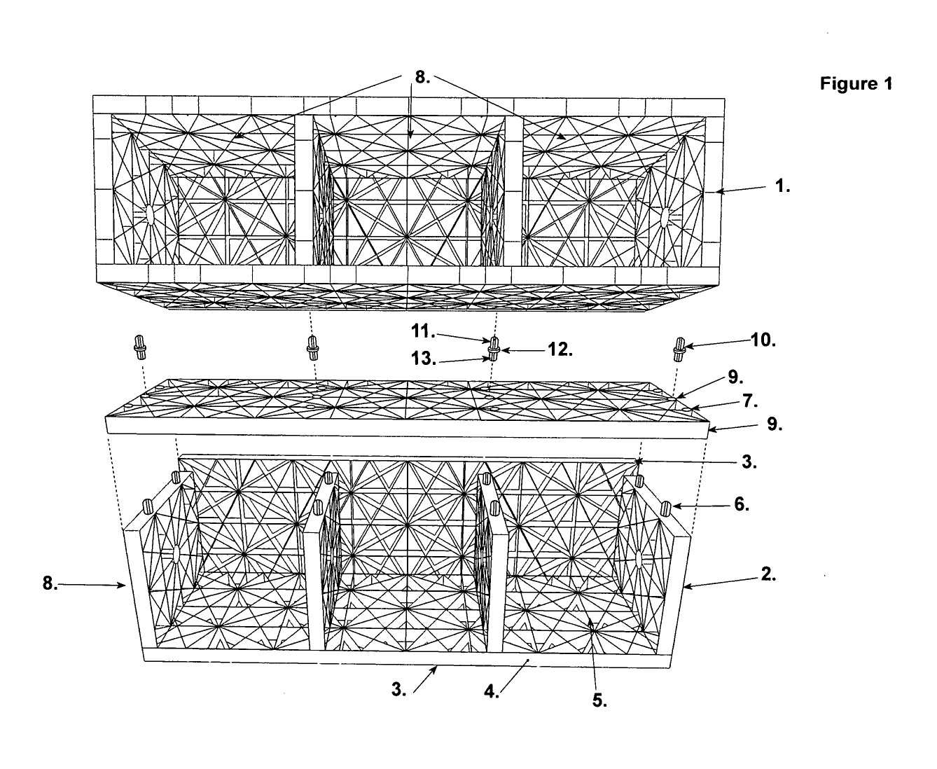

FIG. 1 shows, schematically, a partial exploded view of one embodiment of two garden wall modules of the present invention;

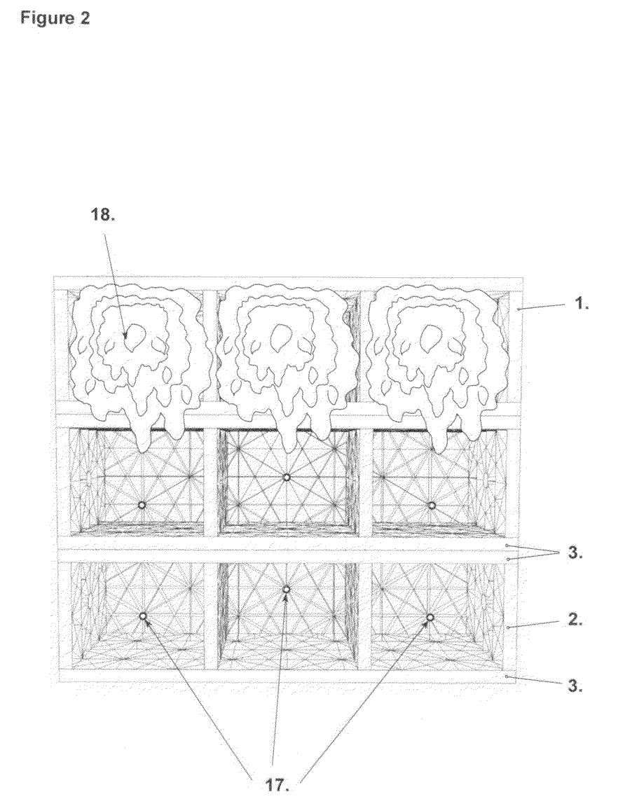

FIG. 2 shows, schematically, a wall garden formed by garden wall modules shown in FIG. 1;

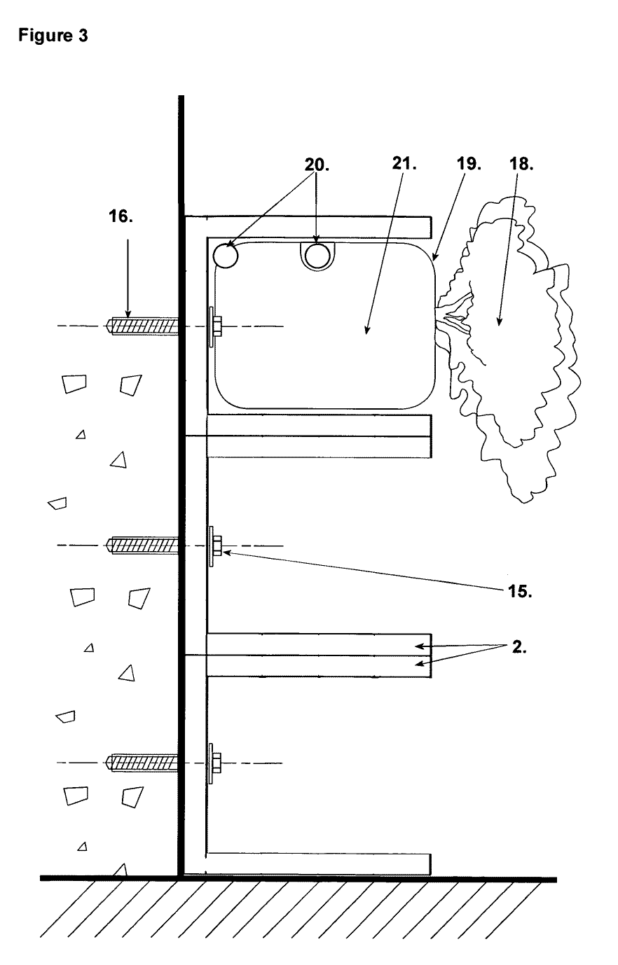

FIG. 3 shows, schematically, a cross-section of the wall garden shown in FIG. 2;

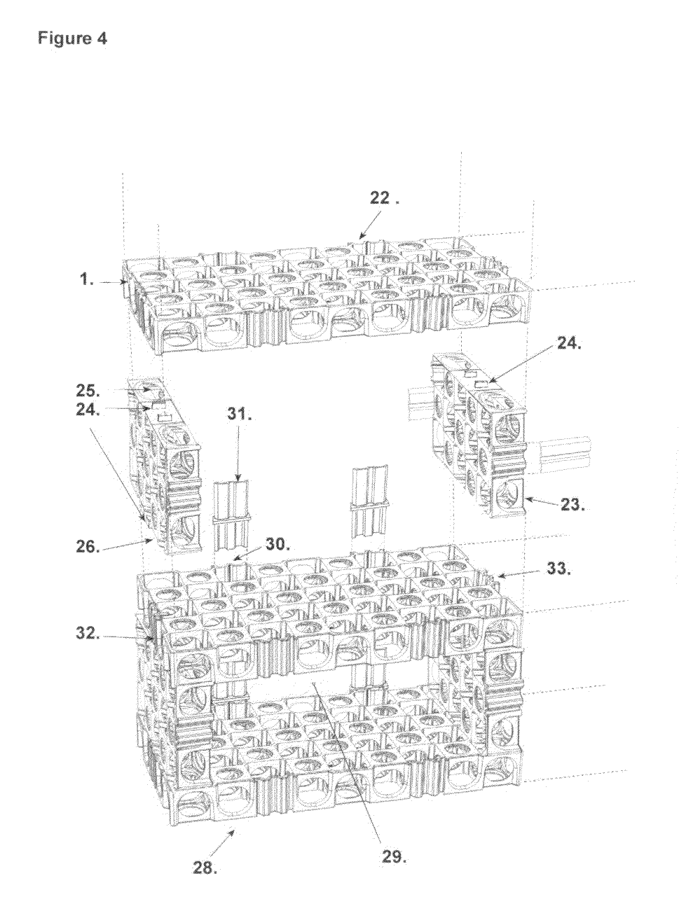

FIG. 4 illustrates a further embodiment of a wall garden module according to the present invention;

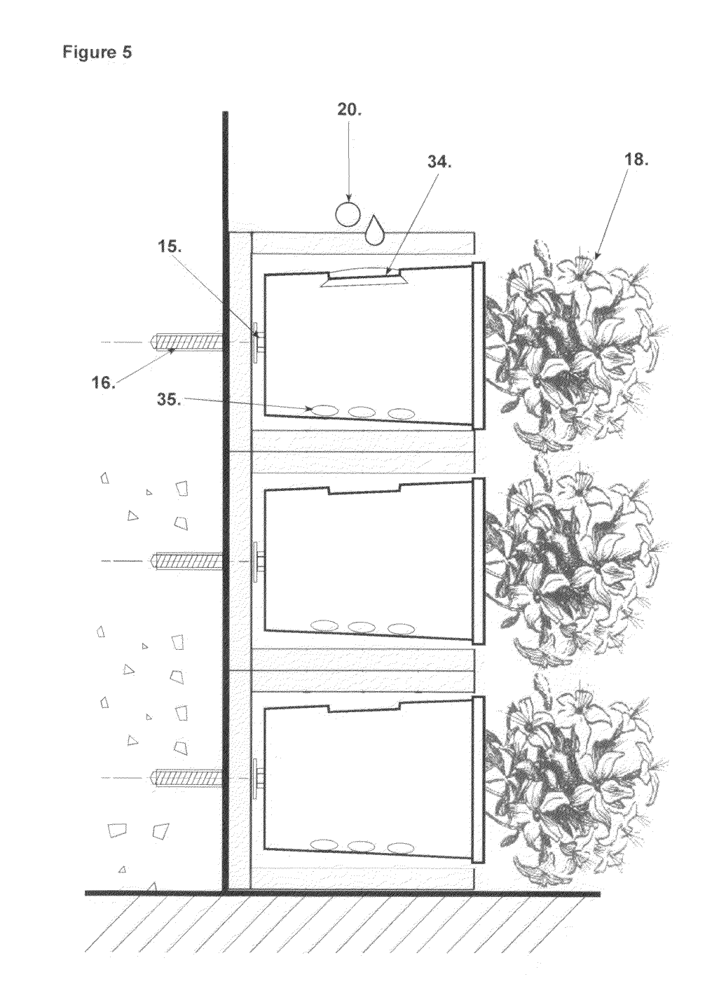

FIG. 5 shows, schematically, a cross-section of the wall garden shown in FIG. 2;

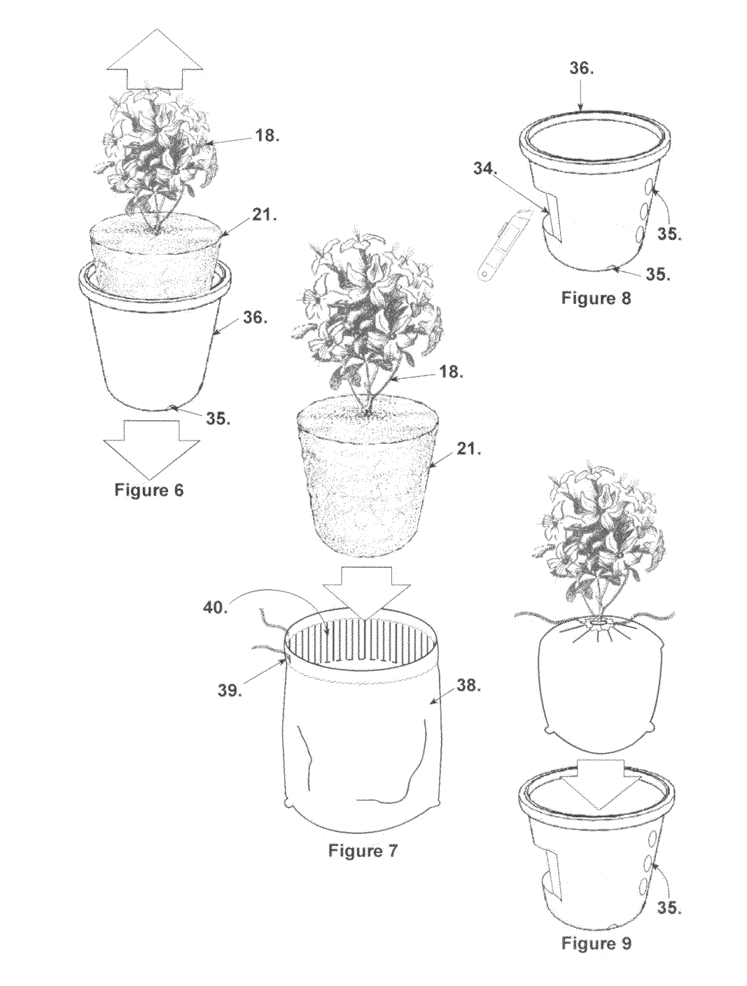

FIGS. 6 to 9 illustrates one embodiment of a method of preparing a plant for incorporation in a wall garden module according to the present invention; and

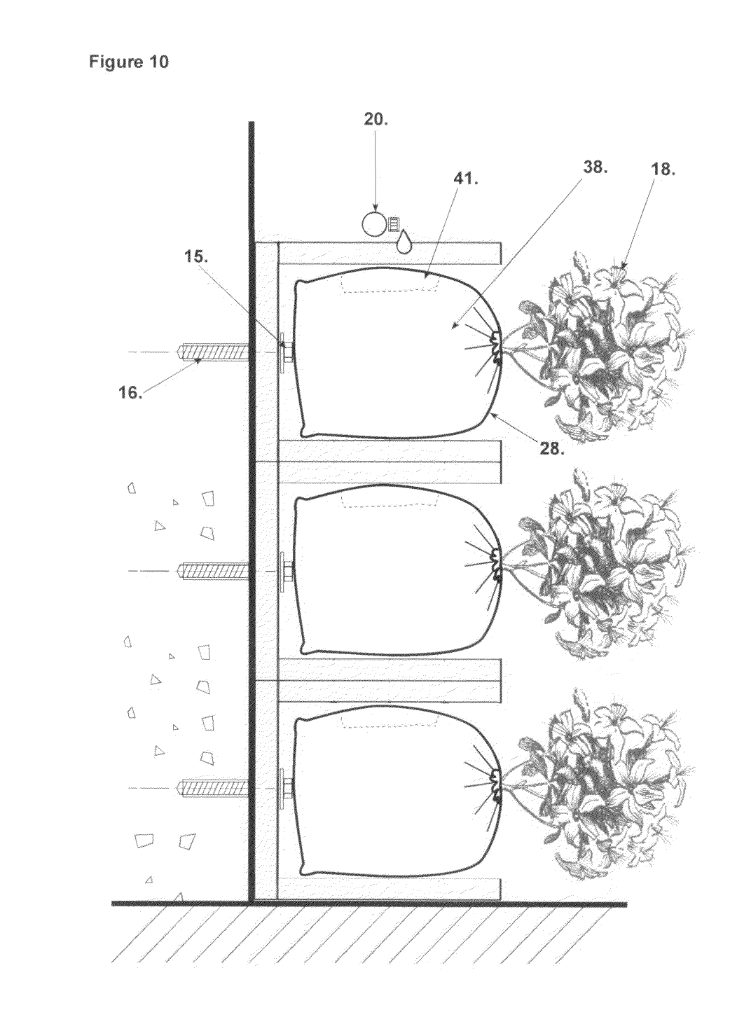

FIG. 10 illustrates schematically a cross-section of a wall garden according to another embodiment of the present invention.

### DETAILED DESCRIPTION OF THE PREFERRED EMBODIMENTS

One embodiment of a wall garden module (1) as shown in FIGS. 1, 2 & 3, comprises four small plates (2) and three large plates (3). Each of the plates (2 & 3) has a peripheral member (4) and a lattice work of web members (5) extending therebetween. As shown in FIG. 1, the small plates (2) have pins (6) which engage in sockets (7) on the large plates (3) forming three chambers (8). Preferably the plates are constructed as those shown in U.S. Pat. No. 6,648,549.

Each large plate has additional sockets (9). To attach one wall garden module (1) to the next one end (11) of the pins (10) are inserted in the additional sockets (9) of one large plate (3) of a first wall garden module (1) up to the collar (12) and a second wall garden module (1) is place on top of the first wall garden module (1) such that the second end (13) of the pins (10) engage in the additional sockets (9) of the adjacent large plate (3) of the second wall garden module (1).

This step is repeated to form as shown in FIG. 2, a wall garden of any desired height.

As shown in FIG. 3, to secure the wall garden modules (1) to the wall (14), any fasteners (15) such as expansion bolts or the like would be suitable, by simple drilling suitable holes (16) in the wall (14) aligned with affixing sockets (17) and inserting an expansion bolts (15) through the affixing socket (17) into the hole (16) and securing the expansion bolt (15).

Plants (18) in any suitable containers (19) are slide into the chambers (8), such the plant (18) extends outside of the wall garden module (1) as shown in FIG. 2. A watering system (20), such as drip system supplies water to the plants, as shown in FIG. 3. The containers (19) could be a water permeable geotextile bag, or a plastics container with openings to allow the water to penetrate into the soil (21). Where required a closure can be used to keep the soil in the open face of the plant container.

Another embodiment is shown in FIG. 4 in which the wall garden modules (28) two large plates (22) and two small plates (23) made of a framework structure. A suitable plate is shown in Australian patent no. 765117. The small plates (23) have a connector (24) on its top (25) and bottom (26) edge, which locks into the opening (27) of the large plates (22), to form a single wall garden module (28) with a single chamber (29). An additional small plate (23) could be used to divide the chamber (29) into two.

To build the wall garden a first layer of large plates (22) are connected together by the male and female end connectors (33 & 32) and small plates (23) are clipped onto the ends of each of the large plates (22) and a second layer of connected large plates (22) are clipped onto the small plates (23). The large plates (22) have at least one connector (30) to which a bracket (31) engages. The bracket (31) is secured to the wall by any suitable means. This process is repeated until the wall garden reaches its required height.

Similarly to the first embodiment plant containers are placed into the chamber (29) with the plants facing outwardly of the wall garden.

This wall garden module (28) because of the framework structure of its plates (22 & 23) allows a watering system to extend horizontally through the length of the large plate layers and vertically through the vertical small plates to water the plants through openings in the plant containers, without external piping.

Another embodiment is shown in FIG. 5 in which the plants (18) in their water permeable bags (19) are placed inside containers (19). The containers (19) have an upper opening (34) and drain holes (35), whereby water drips from the watering system (20) into the opening (34) to pass through the bags (19) into the soil surrounding the plant. Excess water passes through the bottom of the bag (19) and out of the drain holes (35).

Plants (18) are normally purchased in plastics containers (36) with drainage holes (37) located in or adjacent its base. As shown in FIGS. 6 & 7, the plant (18) and its surrounding soil (21) are removed from the container (36) and placed in a water permeable geotextile bag (38) having a draw string opening (39), which is drawn tight around the base of the plant (18) to retain the plant (18) and its soil (21) in the bag (38).

The bag (38) may have a water proof liner (40) located around the draw string opening (39) to retain moisture in the soil.

As shown in FIG. 8, an opening (34) is cut into one side of the plant container (36) with drain holes (35) formed on the opposite side of the plant container (36), and as shown in FIG. 9, the plant in its bag is returned to the plant container (36) which is slid into the chambers (8), such the plant (18) extends outside of the wall garden module (1) as shown in FIGS. 2 & 3, with the opening (34) facing upwardly and the drain holes (35) facing downwardly. Thus the water proof walls of the plant container (36) retain water in the soil, whereby when the soil becomes saturated the excess drains out of the drain holes (35). A watering system (20), such as drip system supplies water to the plants, via the openings (25) and excess water drains out of the drain holes (27. Thus a single watering system can be set up above the top row of plants and the water flows into the openings (34) of the top containers and excess water drains out of the drain holes (35) into the openings (34) of the containers immediately below and its excess water drains into the container below it and so on.

A further embodiment of the present invention is shown in FIG. 10, in which the bag (38) is used without the container (36). If required an opening (41) can be cut into the top of the bag (38) and shade cloth or the like placed in there to keep the soil in place.

A watering system (20), such as drip system supplies water to the plants, via the openings (41) and excess water drains out through the bottom of the bag (38). Thus a single watering system can be set up above the top row of plants and the water flows into the openings (41) of the top bags (38) and excess water drains out through the bottom of the bag (38) into the openings (41) of the containers immediately below and its excess water drains into the bagbelow it and so on.

The present invention and its embodiments provide a modular wall garden support structure which is easy to transport to site, easy to install, easy to install and replace plants.

It should be obvious to people skilled in the art the modifications and variations could be made to the above without departing from the scope or spirit of the present invention.

What is claimed is:

1. A structural garden wall module comprising:
at least two horizontal members;
two or more vertical members which are connected between the at least two horizontal forming at least one void therebetween which is of sufficient size to hold at least one plant container facing horizontally outwardly from the support module.

2. A structural garden wall module according to claim 1, wherein the horizontal and the vertical members are perforated plastic planar members.

3. A structural garden wall module according to claim 2, wherein there is a perforated planar back member which with the horizontal and vertical members form a box like structure with an open face.

4. A structural garden wall module according to claim 3, wherein the vertical perforated planar members have pins on their edges which engage with openings in the perforated plastics planar horizontal members and with openings in the perforated plastics planar back member.

5. A method of constructing a vertical wall garden comprising the steps of:
assembling support modules by connecting two end vertical plate members between two horizontal plate members, thereby forming a first layer of support modules;
connecting said layer to a wall, with an open face of each module extending outwardly from the wall;
positioning further layers of said support modules above the first layer and connecting them to the wall with the open face of each module extending outwardly from the wall, until the required height of the wall garden is reached;
placing a plant and soil within an open top plant container such that when the plant container is horizontal the plant and soil is retained in the container; and
placing said plant containers into the support modules with the open faces of the plant containers and plants facing outwardly from the wall.

6. A method of constructing a vertical wall garden according to claim 5, wherein at least one vertical plate member is placed intermediate the two end plate members.

7. A method of constructing a vertical wall garden according to claim 6, wherein the plant container is a water permeable draw string bag.

8. A method of constructing a vertical wall garden according to claim 7, wherein the plate members have top and bottom perforated planar members which are spaced apart by columnar spacer members so that the structure is cellular in nature.

9. A method of constructing a structural wall garden using modular plant holders and plants in plastics pots having drain holes therein comprising:
stacking the plastics modular plant holders against a wall with the open face of the plastics plant holders facing outwardly from the wall;
affixing said modular plant holders to the wall;
removing said plant and its surrounding soil from its plastics pot;
placing the plant and its surrounding soil into a water permeable geotextile bag having a draw string opening;
closing the draw string opening around the base of the plant to retain the plant and its soil within the bag;
forming an opening in the side of the thus empty plastics pot and drain holes on the opposite side thereof;
placing the thus closed bag into the cut plastics pot;
placing the plastics pot with the bagged plant into one of the modular plant holders, with the plant facing out of the open face of the plastics modular plant holder and the opening in the side of the plastics pot facing upwardly and the drain holes facing downwardly.
